(19) United States
(12) Patent Application Publication
(10) Pub. No.: US 2013/0332208 A1
(43) Pub. Date: Dec. 12, 2013

(54) SYSTEMS AND METHODS FOR PROCESSING ORDERS AND RESERVATIONS USING AN ELECTRONIC DEVICE

(71) Applicant: Sarin S. Mehta, Mountain View, CA (US)

(72) Inventor: Sarin S. Mehta, Mountain View, CA (US)

(73) Assignee: Apple Inc., Cupertino, CA (US)

(21) Appl. No.: 13/494,861

(22) Filed: Jun. 12, 2012

(51) Int. Cl. G06Q 10/02; G06Q 50/12

(52) U.S. Cl. 705/5

(57) ABSTRACT

Disclosed herein are systems, methods, and non-transitory computer-readable storage media for processing reservations at restaurants. A system is described that includes maintaining a wait list for customers waiting to use a physical resource, such as a table at the restaurant. Wait times for customers on the wait list can be dynamically updated depending on the items that are ordered by seated customers.

### BACKGROUND

1. Technical Field

The present disclosure generally relates to a restaurant system and, more specifically, to techniques and systems for improving the restaurant order and reservation processes.

2. Introduction

Restaurants have traditionally used similar techniques for processing customer requests. For example, customer requests to order food generally are communicated to a waiter, who in turn communicates the order to the kitchen staff. Once the kitchen staff has created the dish, the waiter delivers the food to the table for the customer to enjoy. Similarly, restaurant reservations are created by calling the restaurant and speaking to hostess. If a customer arrives at the restaurant without first making a reservation and no tables are available, the hostess places the customer on a waiting list. The hostess can combine the phone reservation requests with the walk-in requests in a single wait list and satisfy the requests in a particular order. The hostess or the waiter can also handle to-go orders over the phone or in person by taking the order, communicating the order to the kitchen, and delivering the food to the customer once the order has been made.

Traditional techniques, however, do have their shortcomings. For instance, ordering is completely dependent on the waiter's availability. A busy waitress may not get around to a customer who is ready to order for five or ten minutes. This idle time is magnified if the waitress is busy and unable to provide menus to the customer for five or ten minutes after the customer has been seated. Other shortcomings include the management of the wait list. During periods of high activity, a hostess may have problems managing the wait list given the number of reservation requests over the phone and in person. Thus, there is a need for improved techniques for processing restaurant orders and reservations.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for making reservations and maintaining a wait list for a resource at a point of interest. A point of interest can be restaurants, movie theaters, museums, auto repair services, or any other point of interest where customers wait for the right to temporarily use a resource. The resource can be physical, such as a table or booth at a restaurant. Each restaurant can include a wait list having entries, where each entry is associated with a customer waiting to use a table at the restaurant. Each entry can include a wait time that estimates the amount of time the customer has to wait before a table will be available for the customer. The wait time for a customer can be recalculated as the customer waits depending on the actions of the customers that are currently using the resource, such as sitting at a table. For example, a seated customer ordering one item is likely to spend less time at the table than a seated customer ordering four items. Thus the number of items ordered, or even more specifically the actual items ordered at a table, can be used to refine the wait time of entries in the wait list. Changes to the wait time or requests for a reservation can be communicated to the restaurant through a portable electronic device operated by a customer.

Once a customer is granted the right to temporarily use a resource of the point of interest, the customer can order one or more items from the point of interest. In one embodiment, a customer can communicate orders for items by using a portable electronic device. In some examples, the portable electronic device can be used to review a menu, receive information associated with the point of interest, place an order, and be billed for an order. In other examples, the portable electronic device can also transmit personal information or a personal profile of the operator of the portable electronic device to the restaurant so that the restaurant can personalize the menu or provide recommendations for items to order. In one example, the personalized menu can be configured to remove items from the menu that contain substances that the customer is allergic to.

In one embodiment, a system is described that is capable of providing recommendations for restaurants in response to a search query for a particular restaurant type, cuisine, ethnicity, price point, rating, or a combination of a few of these factors. The recommendations provided to the customer can be based on the wait time for the next available table at the restaurant. For example, the recommendations can contain only restaurants with a table available within a predetermined period of time. As another example, the recommendations can contain only restaurants capable of providing the customer with a table within a period of time after the customer arrives at the restaurant. These examples can take into consideration the wait list at the restaurants and the distance between the customer and the restaurant when recommending restaurants. In another embodiment, a customer can request to eat at a specified restaurant. A determination can be made whether a table will be available for the customer when the customer arrives or shortly after the customer arrives at the specified restaurant, presuming that the customer is about to head to the restaurant. If the wait list for the specified restaurant does not allow the customer to be seated when arriving at the restaurant or in some other manner is not acceptable to the customer, other similar restaurants that are able to meet the customer's criteria for wait time can be found and presented to the customer. The other restaurants may be similar according to the cuisine type, price point, ethnicity, rating, or other factors.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment;

FIG. 2 illustrates an exemplary cloud computing system;

FIG. 3 illustrates an exemplary system for managing a wait list. System 300 includes one or more restaurants;

FIG. 4 illustrates another exemplary system for managing a wait list;

FIG. 5 illustrates an exemplary ordering system;

FIG. 6 illustrates an exemplary restaurant network;

FIG. 7 illustrates an exemplary notification;

FIG. 8 illustrates an exemplary process for providing wireless services in a restaurant environment;

FIG. 9 illustrates an exemplary process for providing restaurant recommendations in response to a search request; and

FIG. 10 illustrates an exemplary process for processing a restaurant reservation request.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for systems, techniques, and methods for processing restaurant reservations and orders. While the disclosure focuses on reservations and orders in a restaurant environment, it is to be understood by a person of ordinary skill in the art that these teachings can also be applied to making reservations or placing orders in other environments. For example, the teachings here can also be applied to making reservations or placing orders at other points of interest such as a movie theater (e.g., making reservations for a movie), museum (e.g., making reservations for the museum or an exhibit), golf course (e.g., making reservations for a tee time), bank services (e.g., making a reservation to speak to a banker), auto services (e.g., making a reservation to fix a vehicle and potentially updating completion times based on the services ordered), barber shop (e.g., making a reservation for a haircut), and other businesses.

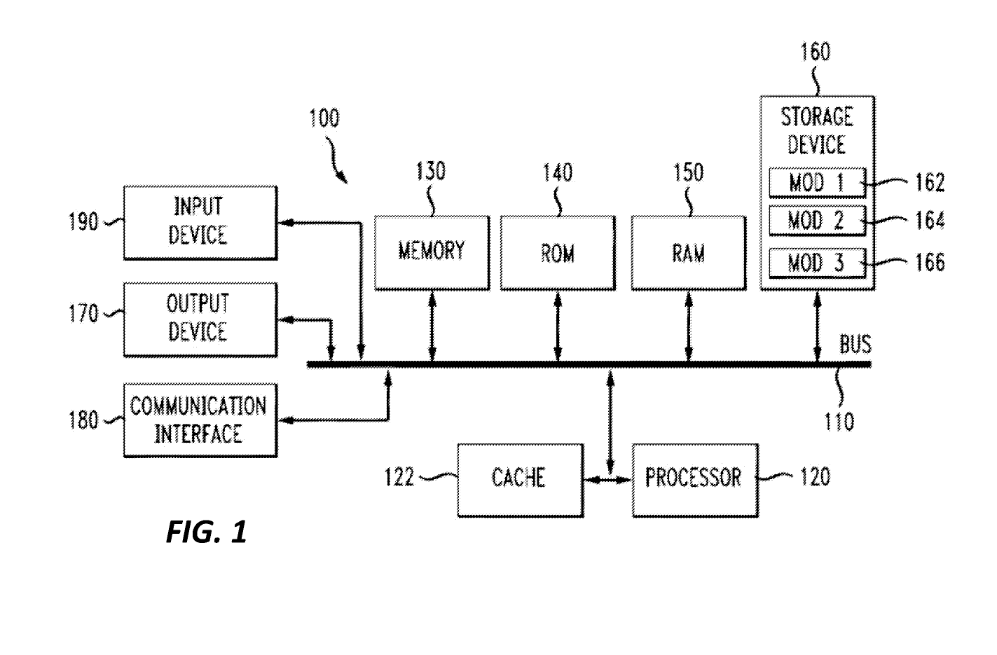

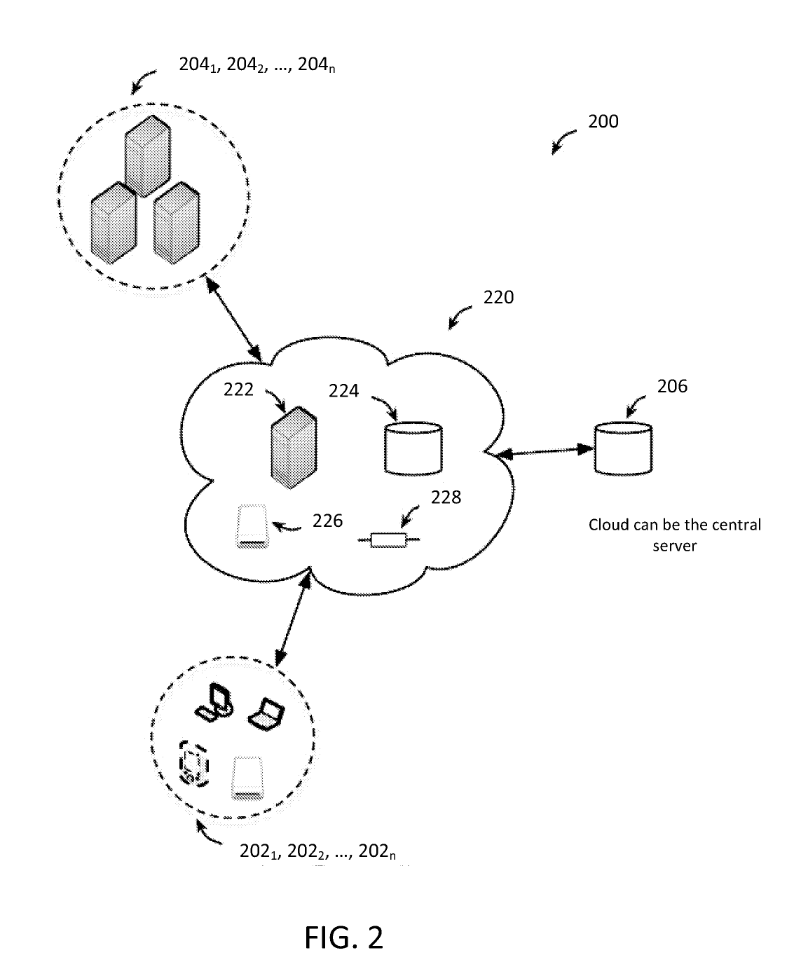

A detailed discussion of the methods and systems surrounding the concept of processing restaurant orders and reservations is provided below. First, a brief introductory description of a basic general purpose system or computing device, which can be employed to practice the concepts, is illustrated in FIG. 1. This is followed by an introductory description of a cloud computing system in FIG. 2. A detailed description of techniques for creating orders and reservations follow. Several variations shall be discussed herein as the various embodiments are set forth. The disclosure now turns to FIG. 1.

### General System

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, a solid state drive, a tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules, Mod1 162, Mod2 164 and Mod3 166, which are modules configured to control the processor 120. These modules may be stored on the storage device 160 and loaded into RAM 150 or memory 130 at runtime or may be stored as would be known in the art in other computer-readable memory locations. Having disclosed some components of a computing system, the disclosure now turns to a description of cloud computing.

### Cloud Computing System

Cloud computing is a type of Internet-based computing in which a variety of resources are hosted and/or controlled by an entity and made available by the entity to authorized users via the Internet. An exemplary cloud computing system configuration 200 is illustrated in FIG. 2, wherein a variety of electronic devices can communicate via a network for purposes of exchanging content and other data. The system can be configured for use on a wide variety of network configurations that facilitate the intercommunication of electronic devices. For example, each of the components of system 200 in FIG. 2 can be implemented in a localized or distributed fashion in a network.

System 200 can be configured to include cloud computing resources 220 (i.e., “the cloud”). The cloud resources can include a variety of hardware and/or software resources, such as cloud servers 222, cloud databases 224, cloud storage 226, cloud networks 228, cloud applications, cloud platforms, and/or any other cloud-based resources. In some cases, the cloud resources are distributed. For example, cloud storage 226 can include multiple storage devices. In some cases, cloud resources can be distributed across multiple cloud computing systems and/or individual network enabled computing devices. For example, cloud computing resources 220 can communicate with servers 204₁, 204₂, . . . , 204ₙ (collectively “204”), database 206, and/or any other network enabled computing device to provide the cloud resources.

Furthermore, in some cases, the cloud resources can be redundant. For example, if cloud computing resources 220 is configured to provide data backup services, multiple copies of the data can be stored such that the data is still be available to the user even if a storage resource is offline, busy, or otherwise unavailable to process a request. In another example, if cloud computing resources 220 is configured to provide software, the software can be available from different cloud servers so that the software can be served from any of the different cloud servers. Algorithms can be applied such that the closest server or from the server with the lowest current load is selected to process a given request.

In system 200, a user interacts with cloud computing resources 220 through user terminals 202₁, 202₂, . . . , 202ₙ (collectively “202”) connected to a network by direct and/or indirect communication. Cloud computing resources 220 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 220 can concurrently accept connections from and interact with multiple electronic devices. Interaction with the multiple electronic devices can be prioritized or occur simultaneously.

Cloud computing resources 220 can provide cloud resources through a variety of deployment models, such as public, private, community, hybrid, and/or any other cloud deployment model. In some cases, cloud computing resources 220 can support multiple deployment models. For example, cloud computing resources 220 can provide one set of resources through a public deployment model and another set of resources through a private deployment model.

In some configurations, a user terminal 202 can access cloud computing resources 220 from any location where an Internet connection is available. However, in other cases, cloud computing resources 220 can be configured to restrict access to certain resources such that a resource can only be accessed from certain locations. For example, if cloud computing resources 220 is configured to provide a resource using a private deployment model, then cloud computing resources 220 can restrict access to the resource, such as by requiring that a user terminal 202 access the resource from behind a firewall.

Cloud computing resources 220 can provide cloud resources to user terminals 202 through a variety of service models, such as Software as a Service (SaaS), Platforms as a service (PaaS), Infrastructure as a Service (IaaS), and/or any other cloud service models. In some cases, cloud computing resources 220 can provide multiple service models to a user terminal 202. For example, cloud computing resources 220 can provide both SaaS and IaaS to a user terminal 202. In some cases, cloud computing resources 220 can provide different service models to different user terminals 202. For example, cloud computing resources 220 can provide SaaS to user terminal 202₁ and PaaS to user terminal 202₂.

In some cases, cloud computing resources 220 can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources 220 such as servers 204 or database 206.

Cloud computing resources 220 can provide a variety of functionality that requires user interaction. Accordingly, a user interface (UI) can be provided for communicating with cloud computing resources 220 and/or performing tasks associated with the cloud resources. The UI can be accessed via an end user terminal 202 in communication with cloud computing resources 220. The UI can be configured to operate in a variety of client modes, including a fat client mode, a thin client mode, or a hybrid client mode, depending on the storage and processing capabilities of cloud computing resources 220 and/or the user terminal 202. Therefore, a UI can be implemented as a standalone application operating at the user terminal in some embodiments. In other embodiments, a web browser-based portal can be used to provide the UI. Any other configuration to access cloud computing resources 220 can also be used in the various embodiments.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are generally recognized meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage. In another example, the present technology can also be configured to allow a user to specify the data stored in cloud storage that can be shared with other users.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

### Wait List Management

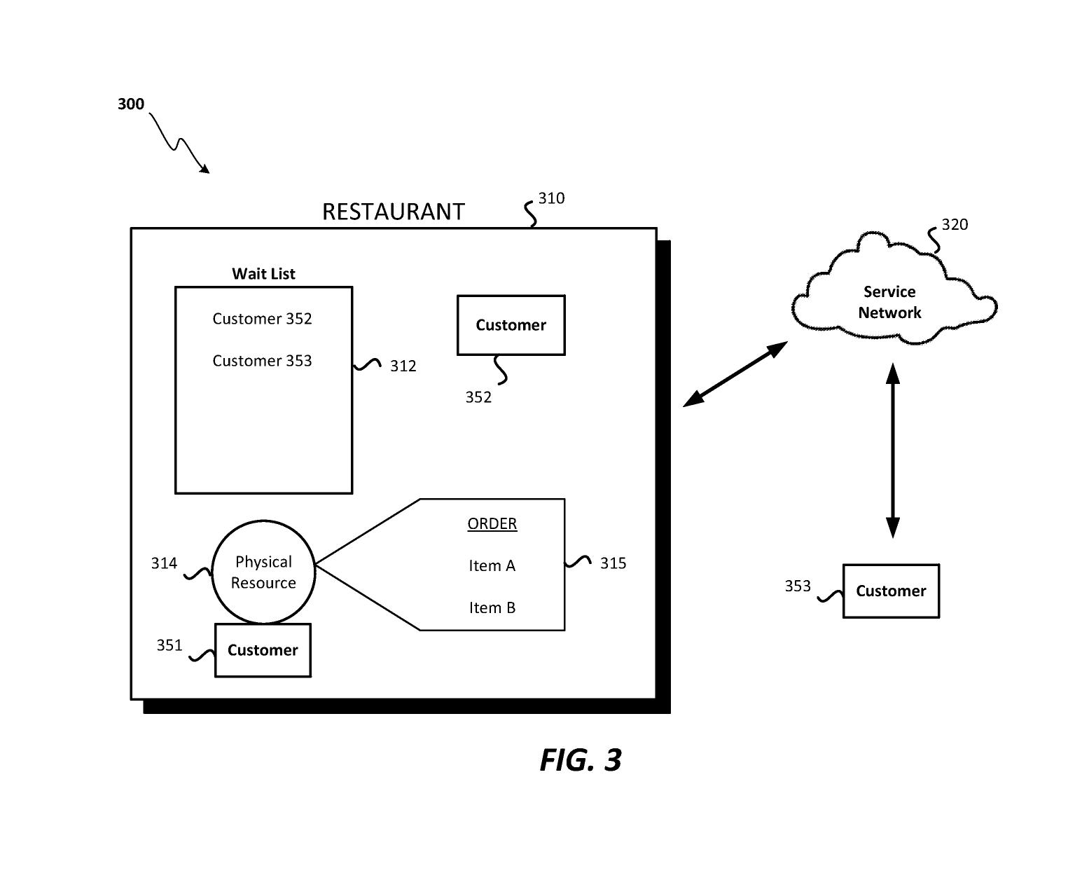

FIG. 3 illustrates an exemplary system for managing a wait list. System 300 includes one or more restaurants. Each restaurant in the system can be associated with a wait list configured to store a list of customers that are waiting for a currently unavailable resource. Once the resource has become available, the restaurant, by using the wait list, selects the next customer to use the resource. Through the use of the wait list, the restaurant can efficiently provide services to customers. Customers not presently in the restaurant can communicate with the restaurant to view menus, place orders, or get a reservation via the service network. Customer communications can include to-go orders or table reservations from remote customers. Each of the restaurants can be connected with the service network, thus forming a network of restaurants capable of communicating with remote customers. While restaurants are being used in this example as an exemplary point of interest, this is by no means limiting. Other exemplary systems can include different types of points of interest, such as movie theaters, museums, auto repair services, or any other point of interest where customers wait for a right to temporarily use a resource. In some examples, different types of points of interest can coexist in the same system. In other examples, some points of interest can be virtual points of interest such as a queue on an online store or a queue to play an online game.

Here, system 300 includes restaurant 310. While only one restaurant is shown in this figure, system 300 can include a plurality of restaurants similar to restaurant 310. Restaurant 310 includes resource 314. Resource 314 can be any physical object in restaurant 310 that a customer can be given the right to temporarily use such as a table, a booth, or a counter space. In other examples, the resource 314 can be other objects related to a point of interest. For example, physical resource 314 can be a vehicle lift when the point of interest is an auto shop. Customers of the auto shop may be interested in knowing when their vehicle will be able to be worked on and also when the work will be finished.

The use of resource 314 is managed by wait list 312. Wait list 312 maintains a list of customers waiting to use resource 314. Wait list 312 can be implemented using a variety of data structures, such as a queue or a list. In some examples, wait list 312 can be updated dynamically as new customers wish to use resource 314, an existing customer finishes using resource 314, or waiting customers no longer wish to wait for resource 314. For example, customers walking in and customers calling in can both be added to wait list 312. Wait list 312 can be configured to manage more than one resource. For example wait list 312 can be configured to manage a plurality of physical resources of restaurant 310. If the physical resources 314 are tables in a restaurant 310, then wait list 312 can manage the list of customers waiting for tables and assign customers to tables as the tables become available. The wait list 312can also be configured to manage a variety of resources, such as booths, tables, and seating in the outdoor area. Here, customer 351 is currently assigned to use resource 314. Customer 352 and Customer 353 are waiting to use resource 314 and thus have been added to wait list 312.

In one embodiment, information surrounding the customer's use of the physical resource 314 can be used to refine the wait times of customers in wait list 312. In other words, a more accurate estimate of how long a particular customer will use resource 314 can be provided once it is known how that particular customer plans on using resource 314. For example, ordering a cup of coffee will likely result in less time spent using a table, while ordering an entire meal will likely result in more time spent at the table. In this example, customer 351 has placed an order 315 for the items A and B. Based the number of items ordered or predetermined values estimating the period of time it generally takes a customer to receive and/or consume items A and B, an estimation of how long the customer intends to use resource 314 can be calculated. The estimated period of time can be used to refine the wait time for customers in wait list 312.

In some examples, customers remote from restaurant 310 can still communicate with restaurant 310. Service network 320 can be configured can allow remote customers such as customer 353 to communicate with restaurant 310. Communications between restaurant 310 and customer 353 can include placing orders, making reservations, or adding a remote customer into wait list 312. Here, wait list 312 includes an entry associated with customer 352 located within restaurant 310, and another entry associated with customer 353 located outside restaurant 310. The ordering of the entries in wait list 312 can depend upon the origin of the entry. In some examples, an entry for a customer located within restaurant 310 can have priority over an entry for a customer located outside restaurant 310. In other examples, the origin of the entry does not affect the ordering of the entries in wait list 312. Instead, the submission time plays a greater role in determining the ordering of the entries in wait list 312. Remote customers can be added to wait list 312 by communicating a request to service network 320. For example, customer 353 can submit a request to use resource 314 by transmitting the request to restaurant 310 via service network 320. Service network 320 can in turn transmit the customer's request to restaurant 310. Restaurant 310 can determine that resource 314 is currently in use and create an entry for customer 353 in wait list 312. When a physical resource becomes available for a customer in wait list 312, a notification can be transmitted to the customer. The notification can be used to inform the customer that the physical resource is now available. In some examples, the timing of the transmission of the notification can take into consideration the distance of the customer from restaurant 310. For example, customer 352, who is within the restaurant, can receive a notification when the physical resource becomes available. Since customer 352 is within the restaurant, customer 352 can reach the physical resource in a short period of time. As a result, the notification can be transmitted to the customer when the table becomes available. As another example, customer 353, who is outside the restaurant, can receive a notification before the physical resource becomes available. The notification can be sent before the physical resource is available in order to provide customer 353 ample time to travel to the restaurant in time for the reservation. For example, GPS capabilities of customer 353, customer 352, or restaurant 310 can be used to determine the travel time between customer 353 and restaurant 310. The travel time can be calculated by estimating the rate of travel and determining the distance between customer 353 and restaurant 310. The travel time can be change as customer 353 moves and thus, the travel time can be dynamically calculated as customer 353 changes location. When the travel time and substantially equal to the remaining wait time for the customer, a notification can be transmitted to inform the customer that it is time to start traveling to the restaurant. In some examples, service network 320 can be implemented using one or more of cloud computing resources 220 described in FIG. 2.

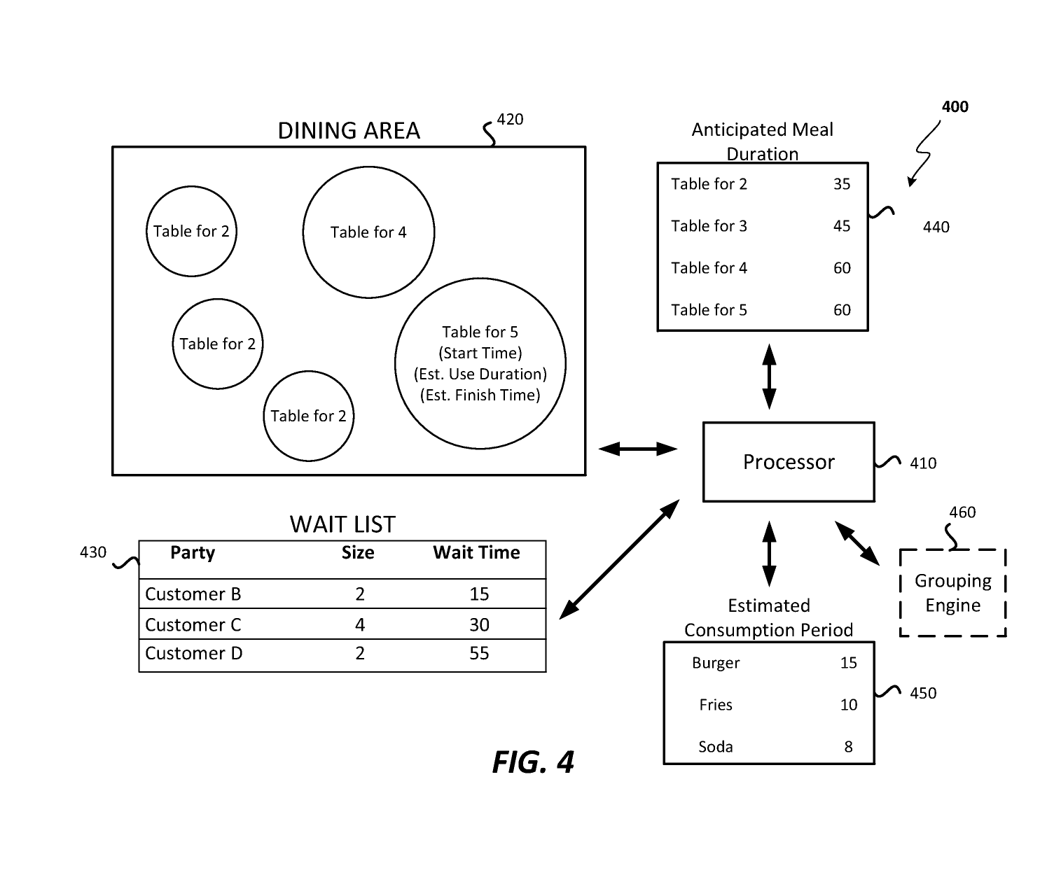

FIG. 4 illustrates another exemplary system for managing a wait list. System 400 includes processor 410, dining area 420, wait list 430, anticipated meal duration chart 440, and estimated consumption period database 450. Processor 410 is configured to manage the assignment of tables from dining area 420. Each table in dining area 420 is configured to seat a specific number of people. Thus, each table is associated with a party size. Here, dining area 420 is configured to seat three parties of two, one table of four, and one table of five. In one embodiment, the assignment of tables can be according to the order of the entries in wait list 430. When tables from dining area 420 become available, they can be assigned to customers in wait list 430. As a customer is assigned to a table, the customer's entry in wait list 430 can be deleted. The customer selected from wait list 430 can depend upon the party size and the wait time. For example, the customer closest to the top of wait list 430 having a party size equal to the size of the available table can be selected. The order of the customer entries in wait list can be based on when customers joined the wait list, when a reservation was made, or the remaining wait time of each entry. In some examples, the order can also be modified to provide select or privileged customers priority over other customers. For example, an entry associated with a privileged customer can be selected before another entry in wait list 430 having a shorter remaining wait time. As another example, a privileged customer can be assigned a shorter wait time than a non-privileged customer. In other examples, processor 410 can use other methods to prioritize the customers in wait list 430.

The status of each table in dining area 420 can be stored in a data structure accessible by processor 410. Alternatively, each table in dining area 420 can include its own processor configured to monitor the status of the table and communicate that status to processor 410. The status of a table can include information about the physical resource such as the time that a customer started using the resource (e.g., start time), an estimate as to how long the customer will use the resource (e.g., estimated use duration), and/or an estimate as to when the customer will finish using the resource (e.g., estimated finish time), and the party size of the table. Other information related to the use of the table or status of the table can also be stored. Regardless of whether the information about the physical resources is stored on processor 410, a data structure associated with processor 410, or on a data structure associated with each table in dining area 420, processor 410 has access to the information and can use the data to determine when tables are available or when tables will be available in the future. This information can be processed to dynamically update the remaining wait time for entries in wait list 430.

In one embodiment, an estimate of when a customer using a resource in dining area 420 will finish using the resource can be used by processor 410 to adjust the wait time of entries in wait list 430. For example if it is known that a customer will take an additional 20 minutes at the table, another customer waiting for a table can be notified that the wait time for the table will be longer than expected, and possibly an additional 20 minutes. In one example, the estimate of how long a customer will use the table can be determined from anticipated meal duration chart 440. The anticipated meal duration chart 440 can provide estimates of how long a customer generally takes to finish a meal depending on party size. Thus, an anticipated finish time can be assigned to the table when a customer is initially granted the right to temporarily use a table (i.e., the customer is assigned to the table). Here, a customer having a party size of two is anticipated to take 35 minutes for a meal. Thus, the estimated finish time associated with the table can be set to 35 minutes when the customer sits down or is assigned the table.

The data in anticipated meal duration chart 440 can be calculated by taking the average, median, mean or other statistical measurement of historically how long it takes a customer to finish using a table according to party size. The data pool used for the calculations can be created by collecting statistics from prior use of the tables in dining area 420 over a predetermined period of time. In some examples, anticipated meal duration chart 440 can be dynamically updated as new statistics become available. In other examples, anticipated meal duration chart 440 can include multiple data sets for different occasions. For instance, a lunch data set can be applied during lunchtime. The lunch data set can anticipate shorter meal durations than a dinner data set since people generally take longer at dinner than lunch. Similarly, a holiday data set can also be applied during holidays. For the same party size, the holiday data set can anticipate longer meal durations than the lunch data set and/or the dinner data set since it meals during the holidays generally take longer than ordinary meals. In other examples, the anticipated finish time can also be determined by taking into consideration data associated with a particular customer. For example, statistics related to the period of time a particular customer takes at a restaurant can be stored, either on a customer's device or on processor 410. The statistics can be sorted by party size, time of day, or other variable. The statistics can be associated with this restaurant or all restaurants that the particular customer visits. The amount of time the particular customer generally takes at a restaurant can be used to determine the anticipated meal duration. Alternatively, the customer data can be combined with data from anticipated meal duration chart 440 to generate the anticipated meal duration.

In one embodiment, the estimated finish time for a table can be refined based on the customer's order. As the estimated finish time is refined, the wait time of entries in wait list 430 can also be refined, thus providing customers waiting a more accurate estimate of when a table will be available. What a customer orders can affect the estimated meal time because the amount the customer orders can be related to the amount of time the customer spends at the table. For example, a customer ordering a burger and fries may spend more time at a table than another customer ordering a burger only. Similarly as more drinks and food are ordered at a table during a meal, the duration of time that the customer remains at the table can change. These changes can result in a change to the wait time for that table. As orders are placed by the customer and processed by processor 410, processor 410 can adjust and refine the wait time for customers in wait list 430.

The relationship between what is ordered and the meal duration can be calculated using estimated consumption period database 450. Estimated consumption period database 450 can include an estimated period of time it takes for a customer to consume a given item. The estimated consumption period can include a plurality of estimated time segments, such as the period of time to process an order for the item, create the item, deliver the item, and consume the item. One or more of these time segments can be combined to represent the estimated consumption period for a given item. Here, it is estimated that a burger will take 15 minutes to consume, fries will take 10 minutes to consume, and a soda will take 8 minutes to consume. Similar to anticipated meal duration chart 440, estimated consumption period database 450 can also include different data sets for different occasions. Processor 410 can use the estimated consumption period for the items ordered, the party size, the time/date (i.e., people generally take longer meals during dinner and the weekends than during lunch and weekdays), and the anticipated meal duration chart 440 to refine the estimated finish time for a table in dining area 420. If the customer orders additional items after the initial order, the estimated finish time for a table can be further revised. This can lead to the wait times in wait list 430 to also be revised.

In some examples, there can be a maximum period of time that a customer can utilize the table. For example, the estimated finish time can be limited to two hours after the start time. In other examples, a percentage deduction can be applied to the estimated consumption period for the items ordered when the number of items order is greater than a predefined number. When a customer orders more than the customer is likely to eat, it can be presumed that the customer is likely taking some of the food home. In this scenario, a deduction can be applied to the estimated consumption period of the items ordered because the customer is not planning on consuming all the items at the restaurant. Processor 410 can optionally communicate with grouping engine 460. Grouping engine 460 can be configured to group the ordered items to more accurately estimate the time it will take to consume the ordered items. For example, an item can be associated with a first consumption period when consumed alone and can be associated with a second consumption period when combined with another item. For instance, a burger can be associated with an estimated consumption period of 15 minutes while a soda can be associated with an estimated consumption period of 8 minutes when they are ordered separately. However, when the items are ordered together, the estimated consumption period of a burger and a soda is 20 minutes, which is less than the estimated consumption period of them individually. Changes to the estimated finish time for a table can change the wait time for one or more entries in wait list 430. In some examples, customers waiting can receive notifications of changes to the wait time. The notifications can be received on an electronic device operated by the customer. The notifications can be received if the change to the wait time is greater than a predefined value (e.g., 10 minutes).

When a customer finishes using a table and relinquishes his rights to temporarily use the table, the resource is available and can be offered to another customer. Processor 410 can track when the customer finishes using the table by monitoring when the customer paid for the items ordered. At this time, the actual meal duration (e.g., the total amount of time that the customer has used the table) can be calculated. In one embodiment, the actual meal duration can be used to refine anticipated meal duration chart 440. This can result in more accurate estimates to the wait time. The actual meal duration can be also stored on the processor 410 or a device of the customer to track the meal duration history of this particular customer. This data can be used to anticipate the meal duration the next time the customer visits the restaurant or other restaurants. In another embodiment, the period of time between placing the order and paying the bill can be calculated. For example, processor 410 can monitor when the first order was placed for the table along with when the bill was paid for the table. The difference between the two time stamps can signify the period of time that the user spent consuming the items ordered. This period of time can be used to further refine the items in estimated consumption period database 450, thus improving the accuracy of the estimated consumption periods. Different statistical measurements can be applied to calculate the estimates in different examples. Over time, the estimates for the meal duration and the consumption period of specific items can be refined and provide a more accurate estimate of the period of time that a customer uses a physical resource. This in turn results in more accurate estimates to the wait time. As the wait time for a customer approaches zero, the customer can be notified that a table is almost ready. In some examples, processor 410 can factor in the current location of the customer by tracking the GPS coordinates of an electronic device carried by the customer so that when the notification is sent, the customer has ample time to return to the restaurant to redeem the customer's reservation.

### Ordering System

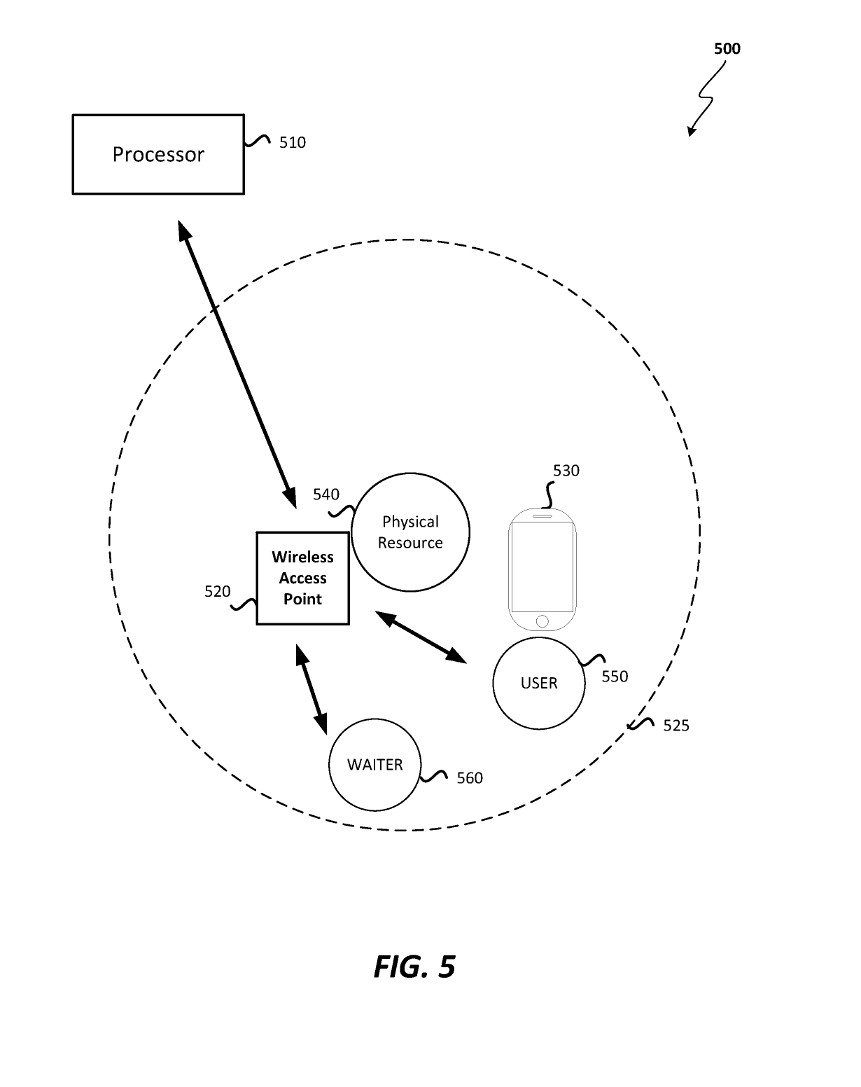

FIG. 5 illustrates an exemplary ordering system. System 500, which can be implemented within a restaurant or other point of interest, includes processor 510, wireless access point 520, portable device 530, and physical resource 540. Wireless access point 520 is configured to provide a wireless communications channel between processor 510 and portable devices such as portable device 530. Wireless access point 520 can be a Wi-Fi, Bluetooth, or other network capable of short range wireless communication. In one system implementation, a single wireless access point can be configured to receive and process communications from portable devices in the restaurant and transmit the information to processor 510. The range of the single wireless access point can cover the entire restaurant or point of interest so that customers or restaurant staff within the restaurant or point of interest can transmit information to and receive information from the processor through their personal devices. This can allow restaurant staff or customers to look at the menu, receive special offers, place orders, and pay the bill through a personal device. In another system implementation, multiple wireless access points can be included in the system. Each wireless access point can have a range that covers a single physical resource (e.g., table). In one example, there is a one-to-one mapping between physical resources and wireless access points. Thus, each wireless access point can communicate with devices within the vicinity of the physical resource and also communicate with the processor. The processor can determine the customer sending the communication by tracking the source of a communication to a specific wireless access point that is associated with a specific table. Here, wireless access point 520 is associated with physical resource 540. Wireless access point 520 is configured to communicate with devices within range 525 of physical resource 540.

In some examples, processor 510 can be configured to perform the same or similar functionality as processor 410 of FIG. 4. Portable devices can be operated by customers of the restaurant as an additional means of communicating with the restaurant over the traditional channels of restaurant staff. Here, user 550 has been assigned to temporarily use physical resource 540. User 550 can use portable device 530 to communicate with processor 510 through wireless access point 520. In one example, processor 510 can broadcast a restaurant menu to wireless access points including wireless access point 520, which in turn broadcasts the menu up to range 525 around physical resource 540. A portable device 530 within range 525 running an application with the appropriate API can receive the menu and optionally place an order. Orders placed by portable device 530 can be routed through wireless access point 520 back to processor 510.

In another example, portable device 530 can initiate communication with processor 510. Portable device 530 operated by user 550 can run a restaurant application when user 550 begins using physical resource 540. The restaurant application can request a menu from wireless access point 520. Wireless access point 520 in turn routes the request to processor 510 for processing. Processor 510 responds with a menu and transmits the menu to wireless access point 520, which in turn routes the menu to portable device 530 for presentation to the user.

Portable device 530 provides user 550 another means for ordering items from the restaurant. In some examples, portable device 530 can be incorporated into the ordering process. For example, information related to the restaurant or point of interest such as a menu can be received on portable device 530. At this point, user 550 operating portable device 530 can place an order for drinks and appetizers. These orders can be transmitted to processor 510 where they can be fulfilled. At a later point in time, waiter 560 can bring the drinks and appetizers over to physical resource 540. After delivering the drinks and appetizers, waiter 560 can take entrée orders. As another example, the entire meal can be ordered using portable device 530. After the order is placed, waiter 560 can optionally come by the table and confirm that the items ordered are correct. In both these examples, waiter 560 can confirm the order on a user interface of processor 510. Alternatively, waiter 560 can also carry a portable device capable of communicating with processor 510 via wireless access point 520. The waiter's portable device can run a different application with additional functionality that is not available to portable device 530. For example, the waiter's portable device can include extra functionality such as reviewing existing orders or retrieve the bill by requesting the applicable data from processor 510. When the waiter's portable device transmits a request to processor 510 to generate the bill, the bill can be transmitted back to the waiter's portable device and/or the client's portable device. If the bill is transmitted to the client's portable device 530, the client can pay for the meal using a credit card or other form of payment. Other functionality that can be performed on the waiter's device include placing orders, cancelling orders, revising orders, changing pricing of items, requesting a check, and customizing items on the menu.

In one embodiment, portable device 530 can transmit a user profile or user statistics to processor 510. Processor 510 can in turn provide recommendations, special offers, or a customized menu to user 550 based on the user profile or user statistics. This can result in a more personalized experience. For example, user statistics on what user 550 has previously ordered at this restaurant or other restaurants can be used by processor 510 to provide dish or drink recommendations to user 550. A history of items previously ordered by user 550 plus optionally the user's rating of each item can be processed by processor 510 to provide a menu that includes recommendations for the user or alternatively, a menu that does not include items that the user is not interested in. As another example, the user profile can include the age of user 550. If the age of user 550 is under the legal drinking age, alcoholic drinks can be removed from the customized menu or remain on the menu but are un-selectable. As another example, the user profile can specify items or ingredients that the user is allergic to or does not like to eat. Processor 510 can take these restrictions into consideration and generate a personalized menu that does not include any undesirable ingredients. As another example, processor 510 can receive the user profile and determine special offers, coupons, or other advertisements are associated with the user profile. These special offers, coupons, or other advertisements can be included in the personalized menu that is presented to user 550. For instance, a user who received an advertisement for 50% off their meal for trying out a restaurant for the first time can be identified by the processor based on the user profile. The processor can remind the user of the special promotion on a header of the personalized menu. When the bill is delivered, the processor can take 50% off the bill for the user's table. This can also serve as a means for the restaurant to track the success of their advertising by keeping statistics on the customers who have come in to redeem special offers. In another example, processor 510 can receive the user profile and determine available gift vouchers or store credits that are associated with the user profile. The personalized menu generated by processor 510 can highlight the available store credit or gift vouchers and present the user an option to redeem the vouchers or use the store credit when paying the bill.

In another embodiment, user 550 can review or submit comments and reviews on the restaurant or specific items on a menu of the restaurant through portable device 530. The comments and reviews can be transmitted to processor 510. The restaurant can take the comments and reviews into consideration when providing recommendations, adding items to the menu, or removing items from the menu. The restaurant can also provide submitted comments and reviews to future customers visiting the restaurant.

### Remote Requests

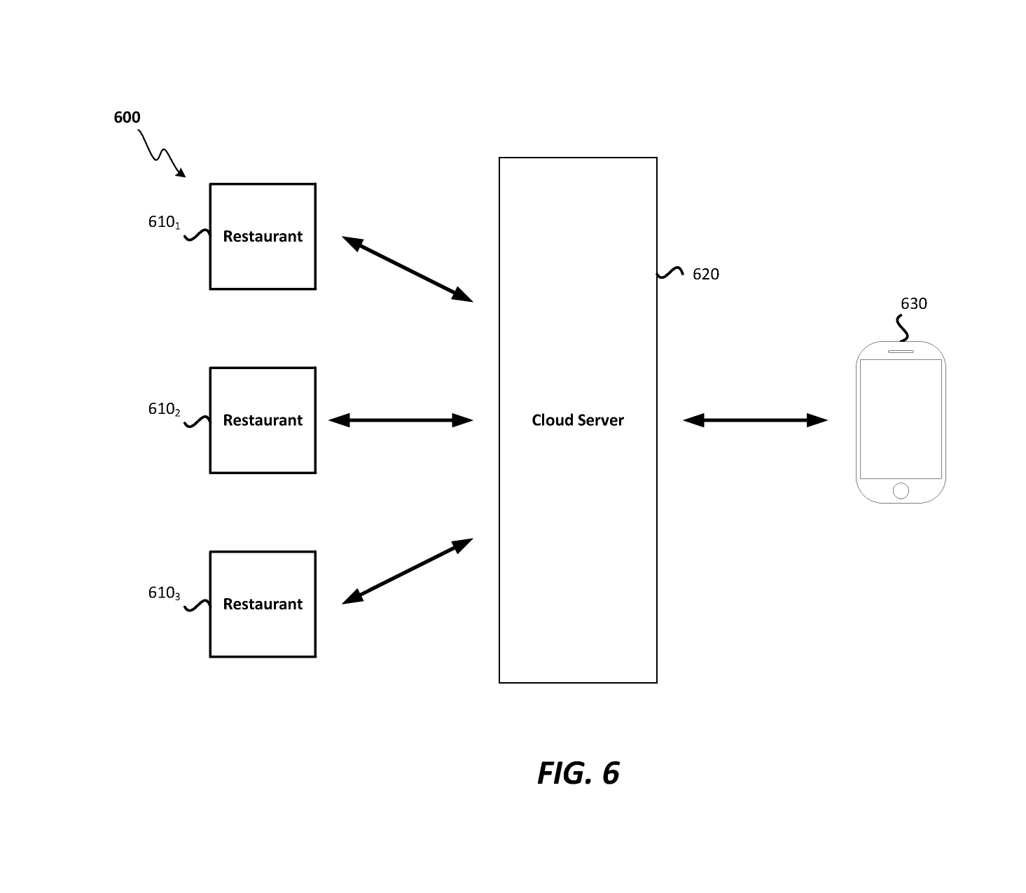

FIG. 6 illustrates an exemplary restaurant network. Restaurant network 600 includes restaurants 610₁, 610₂, and 610₃ (collectively restaurants 610), cloud server 620, and electronic device 630. Cloud server 620 is configured to communicate with restaurants 610 and electronic device 630. The communication includes receiving data, receiving requests, and transmitting data in order to perform a variety of tasks while the customer is remote from the restaurant. The tasks include adding a customer to a waitlist, providing a menu to a customer, placing orders at the restaurant, providing recommendations for restaurants based on the customer's geographical location, suggesting nearby restaurants that are currently able to provide service, and others.

In one embodiment, cloud server 620 can receive a request from electronic device 630 to add a customer onto a wait list for restaurant 610₁. In response to the request, cloud server 620 can perform steps to add the customer to the wait list. For example, cloud server 620 can transmit a request to restaurant 610₁ to add the customer to the wait list. The request transmitted from cloud server 620 can include information associated with the customer. For instance, the profile information can identify the customer or provide contact information for the customer such as a phone number associated with the electronic device. The contact information can be used by the restaurant to contact the customer when a table is ready or if there are changes to the wait time. In another example, cloud server 620 can contact restaurant 610₁ to see if a table is available within a predefined time period. For instance, cloud server 620 can request the wait list of restaurant 610₁ and determine if a table is available within a 15 minute window or alternatively query restaurant 610₁ to see if a table is available within the next 15 minutes. If a table is available, cloud server 620 can add the user to the wait list. If a table is not available, cloud server can query other restaurants nearby restaurant 610₁. The query can include parameters for locating restaurants having the same cuisine type (e.g., burgers, sandwiches, coffee), ethnicity (e.g., Italian, German, French, Japanese), price point (e.g., less than $10, $10-20, $20-40, etc.), popularity rating, quality rating, and others. The results of the query can optionally be further refined to restaurants that have a table available within the predefined time period. Cloud server 620 can respond to electronic device 630 informing the customer the wait time for restaurant 610₁, and optionally a list of restaurants that do have a table available within the predefined time period or a list of restaurants having an acceptable wait time. The acceptable wait time can depend on the distance between electronic device 630 and a restaurant. For example, an acceptable wait time can be a few minutes after the customer arrives in the restaurant with the electronic device. Since the acceptable wait time is dependent on the location of the restaurant with respect to the electronic device, the location of electronic device 630 may need to be broadcasted to cloud server 620. This can allow the customer to quickly locate a restaurant that would meet the customer's requirements.

In another embodiment, cloud server 620 can receive a request from electronic device 630 to query for a restaurant from restaurants 610 using one or more parameters. For example, the query can be for a restaurant that has a table available within a predefined period of time (e.g., restaurant with a table available in the next 15 minutes) or a restaurant within a predefined proximity of electronic device 630 (e.g., restaurant with a table available within two blocks of the electronic device), or both. In one example, cloud server 620 can use the geographical location of electronic device 630 to query for a list of restaurants that are within a predefined distance from electronic device 630. The query can be confined using parameters such as cuisine type, ethnicity, price point, rating, etc. Cloud server 620 can then transmit requests to the list of restaurants to discover the wait time at each restaurant in the list of restaurants. Cloud server 620 can present the results provided from the list of restaurants to electronic device 630 so that the user of electronic device 630 can view a list of restaurants nearby that have a table available. The results can be sorted based on rating of the restaurants, proximity to electronic device 630, cuisine, price point, wait time, and others. The results can be further narrowed by only presenting to the user restaurants that have a table available within a predefined period of time.

In another embodiment, cloud server 620 can be configured to transmit notifications and information to electronic device 630. For example, cloud server 620 can be configured to route communications between a processor of the restaurant (similar or substantially similar to processor 510 of FIG. 5) and electronic device 630. Thus, the functionality and features described in FIG. 5 between processor 510 and portable device 530 can be extended to electronic device 630. In other words, the features and functionality of the restaurant can be extended beyond the range of the wireless access point. For instance, orders, menus, special offers, billing (e.g., prepay before arriving at restaurant), etc. can occur between a restaurant from restaurants 610 and electronic device 630. This information can be routed from the restaurant to electronic device 630 through cloud server 620. In another example, cloud server can transmit notifications to electronic device 630. The notifications can be configured to update the user of electronic device 630 on the status of a reservation. For instance, a notification can be used to notify the user of changes to the reservation, such a change to the wait time. If the wait time changes more than a predetermined amount (e.g., 15 minutes), a notification can be transmitted to electronic device 630 to notify the user of the change in the wait time. This can prevent the user from showing up at the restaurant earlier than anticipated. In another example, a notification can be transmitted to remind the user of electronic device 630 that the table is ready or about to be ready. Optionally, cloud server 620 can periodically track the geographic location of electronic device 630 and calculate the period of time it would take for a person at the geographic location to travel the restaurant. The estimated travel time to reach the restaurant can be factored into when the notification is sent. For example, if cloud server 620 determines that it would take 30 minutes for the user to travel to the restaurant given the current geographical location of electronic device 630 and that the wait time for a table at the restaurant is 30 minutes, cloud server 620 may send the notification to electronic device 620 now to provide the user ample time to reach the restaurant in time for the reservation. The estimated travel time can be calculated using GPS capabilities on electronic device 630, cloud server 620, restaurants 610, or other customer's that are on a wait list of restaurants 610. In other examples, cloud server 620 can be removed from system 600 and restaurants 610 can communicate direction with electronic device 630.

### Notifications

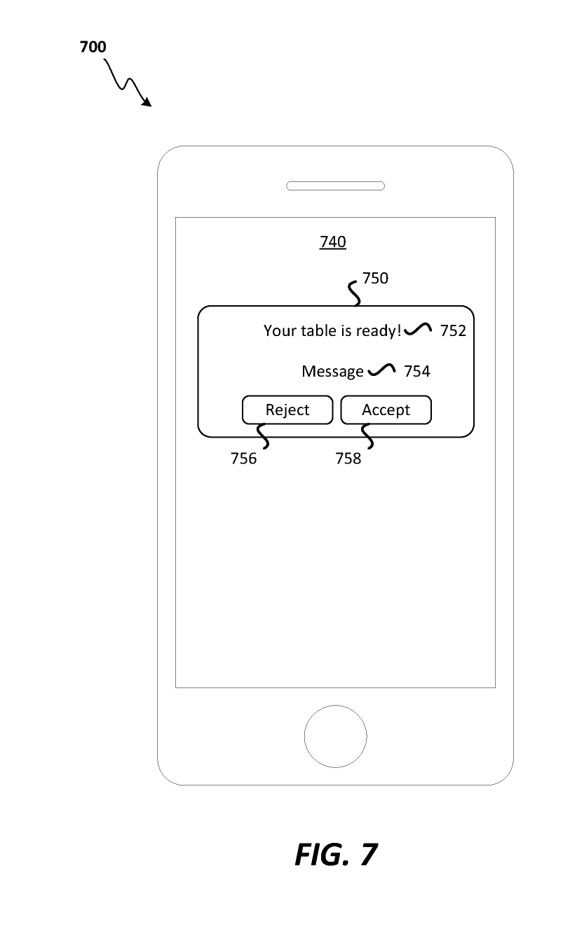

FIG. 7 illustrates an exemplary notification. The notification can be an email or a push notification to notify the recipient of that a physical resource at a point of interest is ready for the customer. Here, the notification is shown as a push notification that is received by electronic device 700 and displayed on display 740, however an email notification can also be used. Notification 700 can be received from cloud server 620 or restaurants 610 of FIG. 6, or alternatively processor 510 of FIG. 5. A push notification is a communication initiated by the cloud or other central server that is sent to a recipient. Push notifications allow a recipient to receive updates or new messages without having to initiate a request to the central server for communications. Notification 750 can be a text message that is received on electronic device 700, a pop-up notification received on electronic device 700, or other digital message received by electronic device 700 that is not in response to a request. As shown here, notification 750 includes title 752, message 754, and options 756 and 758. Title 752 can be a title line associated with notification 750, such as “Your table is ready!” Similarly message 754 can be a message describing the contents of notification 750 or providing additional details about the reservation such as the restaurant name, reservation time, travel time to the restaurant, directions to the restaurant, restaurant menu, restaurant reviews, recommended dishes, etc. In some examples, message 754 can include a link to driving directions. In some examples, title 752 and/or message 754 can be automatically generated by the restaurant or the cloud server.

Options 756 and 758 can provide the recipient user-selectable options to respond to the message. There can be more or fewer options depending on the implementation. For example, the recipient can reject the reservation by selecting option 756. By rejecting the reservation, electronic device 700 can inform the restaurant that the operator of device 700 has rejected the reservation. This can result the table being freed and made available for another customer in the wait list. Alternatively, the user can accept the gift by selecting option 758. When the user accepts the reservation, a message can be sent from electronic device 700 to inform the restaurant that the recipient has accepted the reservation. As a result, the restaurant can prepare the table or hold the table for the customer to arrive. In some examples, selecting option 758 can link the user to another application to look at a menu or place an order for items. If the recipient is unsure whether he or she would like to accept or reject the reservation, notification 750 can be saved within electronic device 700 and a response to notification 750 can be transmitted to the online store at a later point in time.

### Exemplary Methods

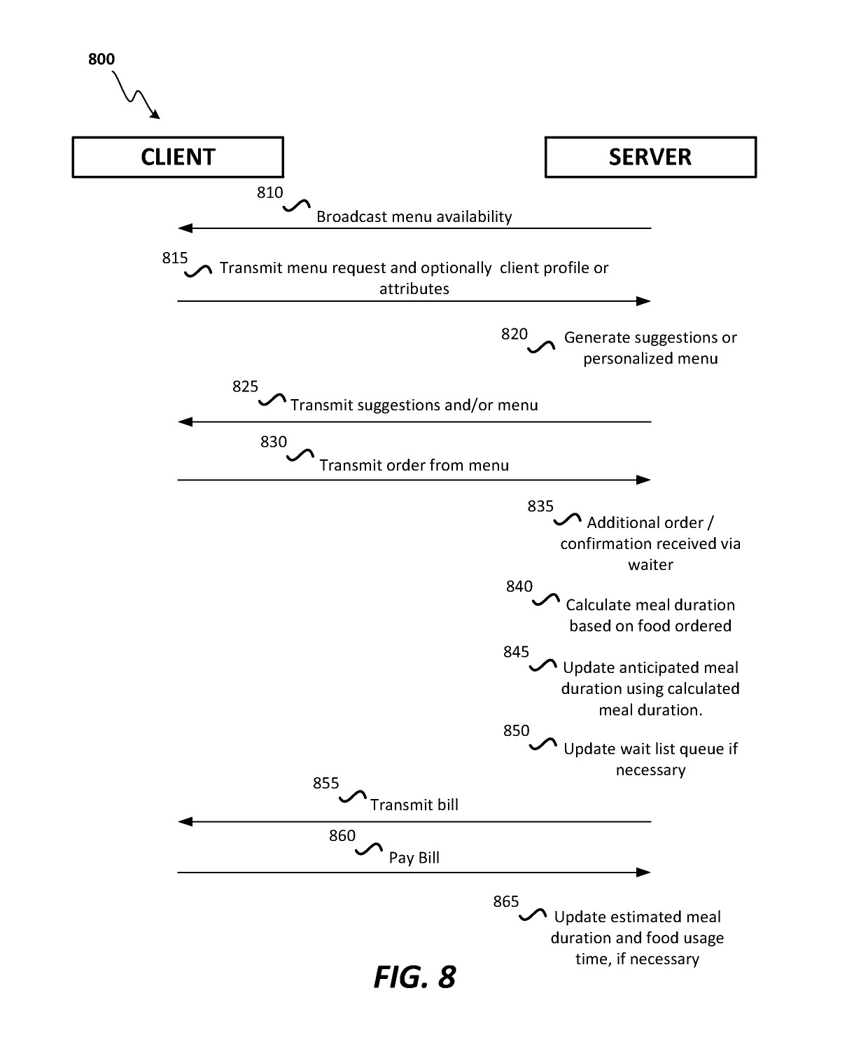

FIG. 8 illustrates an exemplary process for providing wireless services in a restaurant environment. Process 800 can be implemented in computer executable code to be executed by a processor on the client (e.g., portable electronic device operated by the customer) and on the server. Process 800 begins with the server broadcasting menu availability at 810. The broadcast can inform nearby client devices that the restaurant associated with the server has wireless services available. The broadcast can be limited to a range associated with the server. After receiving the broadcast, the client can transmit a menu request to the server at 815. The menu request can optionally include a client profile, client attributes, or other information associated with the client device. In one example, a client ID or other identifier can be transmitted along with the menu request to allow the server to identify the client based on the client ID.

The server generates suggestions for food or beverages, or alternatively a personalized menu at 820. The suggestions or personalized menu can be generated specifically for the client. For instance, the server can take into consideration the user profile or attributes received at 815 when generating the personalized menu or suggestions. In one example, the user profile or attributes can be retrieved from the server using a user ID received from the client. The personalized menu can include special offers, special promotions, vouchers, gift certificates, recommendations, and others. The personalized menu can also not include foods or ingredients that the user dislikes or is allergic to. The personalized menu and/or suggestions are transmitted from the server to the client at 825. In other examples, 810-825 can be substituted with simply broadcasting an un-personalized menu to the client.

In response to the received menu (either personalized or un-personalized), the client transmits to the server an order for one or more items from the menu at 830. Optionally, a waiter can confirm the order or enter additional orders at 835. For example, appetizers and drinks can be ordered at 830 while entrees and desserts are ordered by 835. Based on the items ordered, a meal duration can be calculated at 840. The meal duration can be calculated by using an estimated consumption period database to estimate the time it will take to consume the items ordered. The calculated meal duration can be used to update the anticipated meal duration at 845. Changes to the anticipated meal duration can trigger an update to the wait list queue at 850.

After transmitting an order, but before receiving the bill, the client receives the items ordered and consumes the items. A bill can be transmitted to the client at 855. Once the client has finished consumption of items ordered, the client can pay the bill at 860. In one example, the bill can be paid by handing payment (in the form of cash or credit) to the waitress. In another example, the client can use the client device to pay the bill by transmitting payment information such as a credit card number or bank account number to the server. The server can in turn receive the payment information and submit a request with the client's financial institution for payment. Once payment has been paid, the server can provide updates, if necessary, to the anticipated meal duration chart and/or the estimated consumption period database at 865. The updates can be to revise and refine the database or chart based on statistics generated from serving the client. For example, the actual meal duration can be analyzed to refine the anticipated meal duration. Statistics of several meals can be used to refined the consumption period database. The actual meal duration can be calculated from when the party sits down at the physical resource, when the menu request is received at 815, or some other point in time. The actual meal duration can end when the bill is paid or when the client leaves the physical resource.

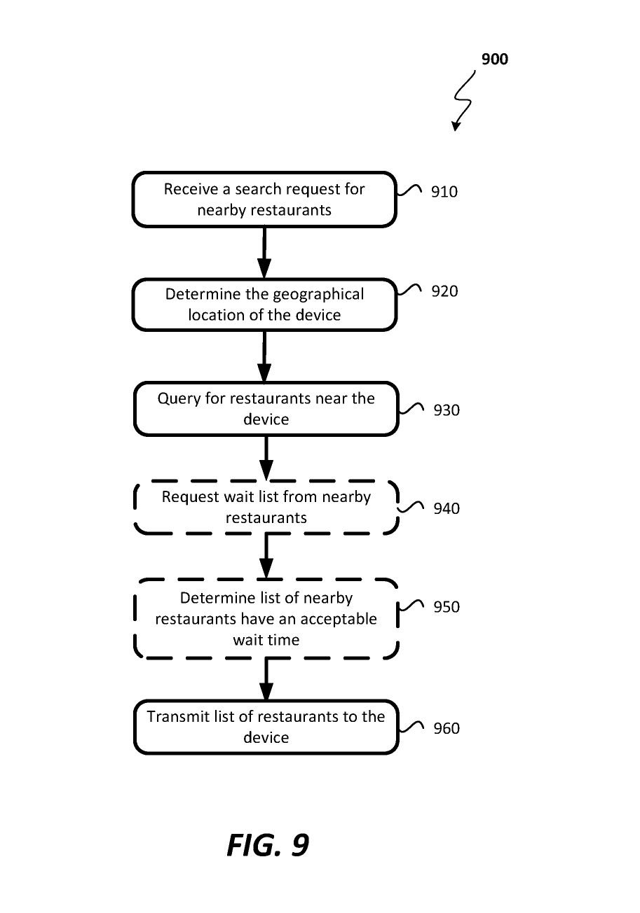

FIG. 9 illustrates an exemplary process for providing restaurant recommendations in response to a search request. A client can submit a search request for restaurants that meet certain criteria. Process 900 can be implemented in computer executable code to be executed by a processor. The processor can belong to a cloud server. Process 900 begins by receiving a search request for nearby restaurants at 910. The search request can be transmitted from a customer operating a portable electronic device and can include a search query for a restaurant using one or more factors. The factors include, but are not limited to, cuisine, ethnicity, rating, price point, popularity, wait time, and distance. After receiving the search request, the geographical location of the device can be determined at 920. This can include receiving the GPS coordinates of the device in the search request or alternatively requesting the GPS coordinates or geographical location from the device. Once the geographical location of the device is determined, a query can be performed for restaurants that are nearby the device at 930. The query can be constrained according on the factors received in the search request, and optionally any default search constraints. For example, process 900 can by default search only for restaurants that are open or restaurants that are within a predetermined distance from the device. The query can be performed on data stored in the cloud server quickly, without requiring communication with the restaurants.

A list of restaurants that meet the user-defined factors and the default search constraints (if any) are returned from the search request. The list of restaurants can be transmitted to the device at 960. Alternatively, the list of restaurants can be refined or revised to a subset of the list of restaurants that have a table available within a predefined period of time. In some examples, the predefined period of time can vary depending on the restaurant, the geographic location of the restaurant, or the distance of the restaurant from the device. For example, the subset can include restaurants that have a table available when the user reaches the restaurant assuming that the user was to leave for the restaurant shortly. In other words, the subset can include restaurants that would have a table available for the user if the user were to leave for the restaurant within a fixed period of time, for example the next 5 minutes. By narrowing the list of restaurants to a subset that includes restaurants that can service the user when the user arrives at the restaurant, the user is presented a smaller list that may provide more accurate results. In one example, the list of restaurants can include restaurants of a selected ethnicity (e.g., Italian) that are within a five block radius of the user's device. A subset of the list of restaurants can be generated that includes restaurants from the list that have a table available for the user when the user arrives at the restaurant. As shown in process 900, the wait list of each restaurant in the list of restaurants can be requested at 940. Since the wait list at each restaurant can change dynamically in real time, process 900 can submit requests for the wait list of each restaurant. In some examples, the request for the wait list can be accompanied with a request to make a reservation. This can allow a reservation to be secured as the user decides whether he or she would like to eat at that restaurant. If the user selects to not dine at the restaurant, the reservation can be cancelled. After the wait list or wait time has been received from the list of restaurants, process 900 can determine which restaurants from the list have an acceptable wait time at 950. An acceptable wait time can be determined according to user preferences or the distance that the restaurant is with respect to the device. For example, an appropriate wait time can be a value that allows the user to be serviced when the user arrives at the restaurant, taking into consideration traveling time. In other examples, process 900 can be performed in a different order that includes some, all, or other actions not shown in FIG. 9.

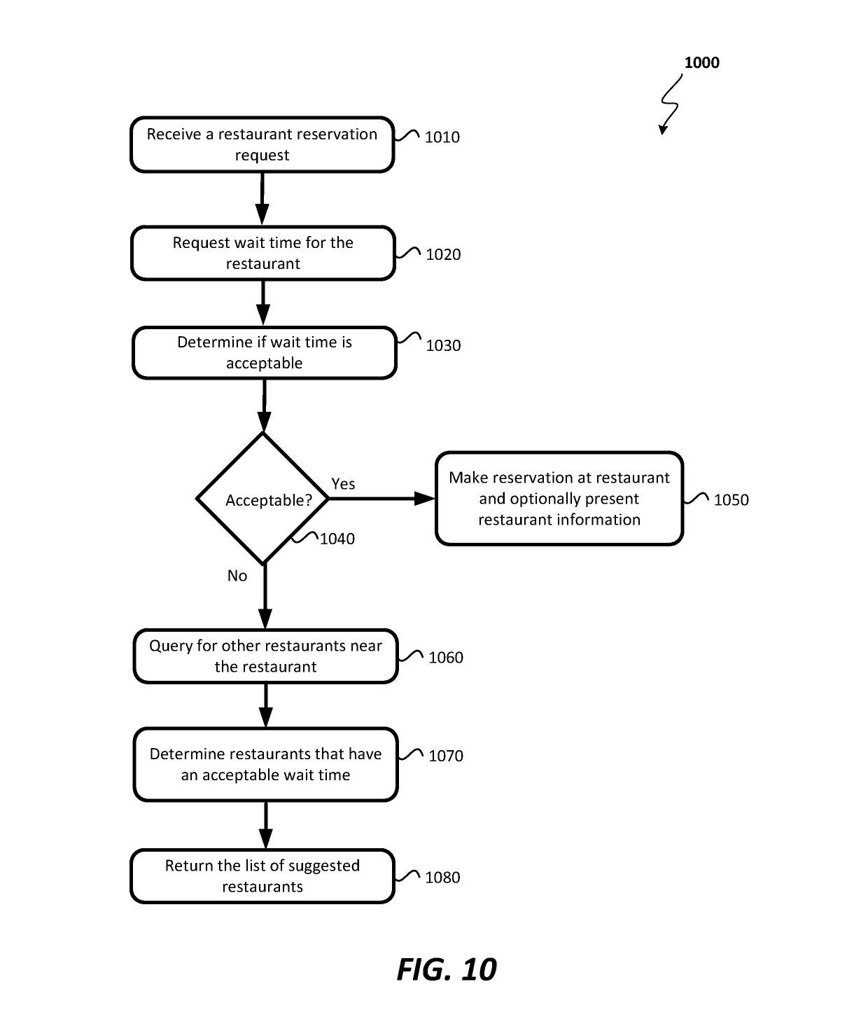

FIG. 10 illustrates an exemplary process for processing a restaurant reservation request. A reservation request can be submitted by a client device. Process 1000 can be implemented in computer executable code to be executed by a processor. The processor can belong to a cloud server. Process 1000 begins by receiving a restaurant reservation request at 1010. The restaurant reservation request can include the name of a restaurant, a restaurant ID, or other identifier configured to identify the restaurant. The request can also include the number of people in the party. In some examples, the reservation request can be for the next available table at the restaurant, factoring in traveling time to reach the restaurant. Process 1000 can request the wait time for the restaurant in 1020. Once the wait time is received, process 1000 can determine if the wait time is acceptable at 1030. A wait time can be acceptable if the wait time is less than a user-defined or predefined limit. For example, a user can specify that a wait time less than 30 minutes is acceptable. Alternatively, the travel time for the user to reach the restaurant and the wait time can be compared to determine if the wait time is acceptable. For example, if the wait time is within ten minutes of the estimated travel time for the user to reach the restaurant, then the wait time is acceptable. The ten minutes can be a user defined value that specifies how long the user is willing to wait for an available table after arriving at the restaurant.

If the wait time is acceptable at 1040, a reservation can be made by adding the user of the client device to the wait list at 1050. The reservation can be made by transmitting a reservation request to the restaurant. In some examples, the reservation request is transmitted along with the request for the wait time at 1020. This ensures that the wait time value used in determining if the wait time is acceptable at 1030 remains the same. Since the reservation has already been made in these examples, the reservation does not need to be made but simply maintained. The restaurant may need to be contacted however if the wait time is not acceptable in order to release the reservation for others. Optionally, additional information can be requested from the restaurant and transmitted to the client device. For example, the restaurant menu, restaurant specials, or vouchers and certificates available to the user of the client device can be transmitted to the client device. This can allow the user to review the menu and other restaurant information before arriving at the restaurant, thus potentially shortening the time the user spends at the restaurant making decisions on what he or she wishes to order.

If the wait time is not acceptable at 1040, process 1000 can cancel a reservation at the restaurant if a reservation was made at 1020. Process 1000 can also query for other restaurants near the restaurant to determine if other options are available at 1060. The query can be based on attributes of the requested restaurant. For example, if the requested restaurant is a Japanese restaurant, the query can locate other Japanese restaurants nearby. The attributes of the restaurant that are used during the query can be user specified or predefined. Once the list of restaurants is found, process 1000 can determine if the list of restaurants have an acceptable wait time at 1070. This can include requesting the wait time at the list of restaurants and evaluating the wait time using one or more strategies described above. A list of restaurants having an acceptable wait time is returned to the client device at 1080. In other examples, process 1000 can be performed in a different order that includes some, all, or other actions not shown in FIG. 10.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, solid state drives, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied other types of files to control the secure deletion of those files and other copies of those files from storage. Those skilled in the art will readily recognize various modifications and changes that may be made to the principles described herein without following the example embodiments and applications illustrated and described herein, and without departing from the spirit and scope of the disclosure.

1. A method, comprising:
assigning a customer temporary rights to use a resource, the resource being associated with a wait list that includes an estimated wait time for another customer waiting to use the resource;
receiving a request including at least one good to be consumed by the customer during use of the resource;
mapping a good in the order to an estimated consumption period;
calculating an estimated finish time according to the estimated consumption period; and
revising the estimated wait time based on the estimated finish time.

2. The method of claim 1, wherein the order is received from a portable electronic device operated by the customer.

3. The method of claim 2, further comprising:
receiving, from the portable electronic device, profile information of the customer;
transmitting, to the portable electronic device, a menu that has been personalized according to the profile information.

4. The method of claim 3, wherein the profile information includes an ingredient that the customer is allergic to and the transmitted menu does not include any items that contain the ingredient.

5. The method of claim 3, wherein the profile information includes an offer that was previously presented to the customer.

6. The method of claim 1, wherein the estimated consumption period varies depending upon the time of day.

7. The method of claim 1, further comprising notifying the another customer of a revised estimated wait time when a change to the estimated wait time is greater than a predefined value.

8. The method of claim 1, further comprising notifying the another customer, on a device of the another customer, that the physical resource is ready for use when a travel time for the another customer to reach the physical resource is approximately the estimated wait time.

9. A system, comprising:
a portable device configured to transmit a reservation request for a restaurant, the portable device being disposed at a geographic location;
a plurality of restaurants, each restaurant having a waiting list, wherein the restaurant is part of the plurality of restaurants; and
a server configured to communicate with the portable device and the plurality of restaurants, the server being further configured to:
receive the reservation request;
retrieve, from the restaurant, a wait time for the restaurant;
determine if the wait time is acceptable; and
query for other restaurants from the plurality of restaurants when the wait time is unacceptable.

10. The system of claim 9, wherein the wait time is acceptable when the difference between the wait time and a travel time from the geographical location of the portable device to the restaurant is less than a predefined limit.

11. The system of claim 9, wherein the wait time is unacceptable when the difference between the wait time and a travel time from the geographical location of the portable device to the restaurant is greater than a predefined limit.

12. The system of claim 9, wherein the wait time is acceptable when the wait time is less than a predefined value.

13. The system of claim 9, wherein the other restaurants are the same ethnicity as the requested restaurant.

14. A computer readable medium comprising computer program code causing a device to perform a method comprising:
assigning a customer temporary rights to use a physical resource, the physical resource being associated with a wait list that includes an estimated wait time for another customer waiting to use the physical resource;
receiving an order of at least one physical good to be consumed by the customer during use of the physical resource;
mapping a physical good in the order to an estimated consumption period;
calculating an estimated finish time according to the estimated consumption period; and
revising the estimated wait time based on the estimated finish time.

15. The computer readable medium of claim 14, wherein the order is received from a portable electronic device operated by the customer.

16. The computer readable medium of claim 15, further comprising:
receiving, from the portable electronic device, profile information of the customer;
transmitting, to the portable electronic device, a menu that has been personalized according to the profile information.

17. The computer readable medium of claim 16, wherein the profile information includes an ingredient that the customer is allergic to and the transmitted menu does not include any items that contain the ingredient.

18. The computer readable medium of claim 16, wherein the profile information includes an offer that was previously presented to the customer.

19. The computer readable medium of claim 14, wherein the estimated consumption period varies depending upon the time of day.

20. The computer readable medium of claim 14, further comprising notifying the another customer of a revised estimated wait time when a change to the estimated wait time is greater than a predefined value.

21. The computer readable medium of claim 14, further comprising notifying the another customer, on a device of the another customer, that the physical resource is ready for use when a travel time for the another customer to reach the physical resource is approximately the estimated wait time.
